(19) United States
(12) Patent Application Publication
(10) Pub. No.: US 2015/0175794 A1
(43) Pub. Date: Jun. 25, 2015

(54) ALKALI-SOLUBLE RESIN COMPONENT AND PHOTOSENSITIVE RESIN COMPOSITION COMPRISING THE SAME

(71) Applicant: CHI MEl CORPORATION, Tainan City (TW)

(72) Inventor: Fu-Chien LIU, Tainan City (TW)

(21) Appl. No.: 14/332,770

(22) Filed: Jul. 16, 2014

(30) Foreign Application Priority Data
Dec. 20, 2013 (TW) 102147494

(51) Int. Cl. C08L 33/08

(52) U.S. Cl. CPC C08L 33/08

(57) ABSTRACT

An alkali-soluble resin component includes a bisphenol fluorene-based resin, a quaternary ammonium salt compound, and a solvent. The quaternary ammonium salt compound is in an amount greater than 0.07 part by weight and smaller than 0.82 part by weight based on 100 parts by weight of the bisphenol fluorene-based resin.

### CROSS-REFERENCE TO RELATED APPLICATION

This application claims priority of Taiwanese Patent Application No. 102147494, filed on Dec. 20, 2013, the entire disclosure of which is hereby incorporated by reference.

### BACKGROUND OF THE INVENTION

1. Field of the Invention

The invention relates to an alkali-soluble resin component, more particularly to an alkali-soluble resin component which includes a bisphenol fluorene-based resin, a quaternary ammonium salt compound, and a solvent.

2. Description of the Related Art

In order to increase contrast ratio and display quality of a liquid crystal display, a black matrix is usually placed in the gaps formed between pixels of a color filter, so as to prevent light escaped between the pixels. Thus high quality of the contrast and hue of LCD can be obtained. The conventional black matrix is formed of chromium or chromium oxide by vaporization deposition process. However, such process is complicated and the material is expensive. A solution for these problems is to apply photosensitive resin compositions to the black matrix through photo lithographic processes.

The photosensitive resin composition used in the art usually includes an alkali-soluble resin component, a photoinitiator, a black pigment, and a solvent.

The alkali-soluble resin component commonly used in the art usually has a heterogeneous problem. That is, the ingredients in the alkali-soluble resin component are poorly compatible with each other so that the phenomena such as precipitation and turbidity may occur. Thus, in the subsequent process such as a color filter manufacturing process, the phenomena of precipitation and turbidity in the alkali-soluble resin component may adversely affect the yield of the color filter. Moreover, while manufacturing an alkali-soluble resin for the alkali-soluble resin component, the ingredients for producing the alkali-soluble resin are difficult to react with each other.

In view of the foregoing, there is a need in the art to develop an alkali-soluble resin component having a homogeneous state. Furthermore, when manufacturing an alkali-soluble resin, such as bisphenol fluorene-based resin, it is also desirable that the ingredients have superior reactivity.

### SUMMARY OF THE INVENTION

A first object of the present invention is to provide an alkali-soluble resin component having a homogeneous state and to enhance the reactivity of the ingredients for producing an alkali-soluble resin, such as a bisphenol fluorene-based resin, for the alkali-soluble resin component.

A second object of the present invention is to provide a photosensitive resin composition which includes the alkali-soluble resin component and a photoinitiator.

According to a first aspect of this invention, an alkali-soluble resin component which includes a bisphenol fluorene-based resin, a quaternary ammonium salt compound and a solvent is provided. The quaternary ammonium salt compound is in an amount greater than 0.07 part by weight and smaller than 0.82 part by weight based on 100 parts by weight of the bisphenol fluorene-based resin. The bisphenol fluorene-based resin is represented by formula (I):

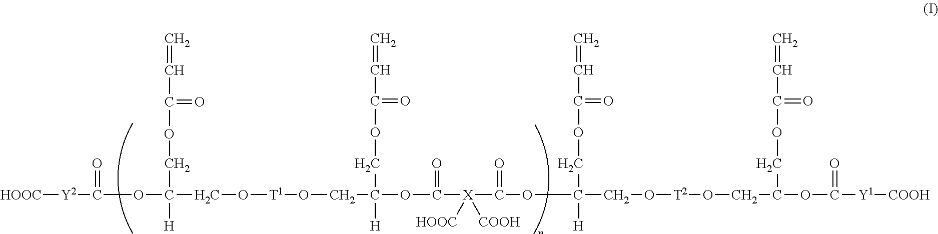

wherein T¹ and T² are independently represented by

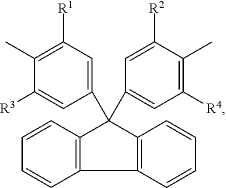

wherein R¹, R², R³, and R⁴ are independently selected from the group consisting of hydrogen, halogen, a C₁-C₅ alkyl group, a C₁-C₅ alkoxy group, a C₆-C₁₂ aryl group, and a C₆-C₁₂ aralkyl group;

X is a tetravalent organic group;

Y¹ and Y² independently represent a bivalent organic group; and

n represents an integer ranging from 1 to 30, a plurality of X's are the same or different and a plurality of R⁴'s are the same or different when n is 2 or more.

According to a second aspect of the present invention, a photo-sensitive resin composition which includes the aforesaid alkali-soluble resin component and a photoinitiator is provided.

### DETAILED DESCRIPTION OF THE PREFERRED EMBODIMENTS

### <Bisphenol Fluorene-Based Resin>

In the present invention, a bisphenol fluorene-based resin is an alkali-soluble resin. Examples of the alkali may include, but are not limited to, sodium hydroxide, potassium hydroxide, sodium carbonate, sodium bicarbonate, potassium carbonate, potassium bicarbonate, sodium silicate, sodium methyl silicate, ammonia, ethylamine, diethylamine, dimethyl ethanolamine, tetramethylammonium hydroxide, tetraethylammonium hydroxide, choline, pyrrole, pyridine, and 1,8-diazabicyclo-[5.4.0]-7-undecene.

In the present invention, a preparation method of the bisphenol fluorene-based resin includes the following steps: subjecting a first mixture to a ring-opening reaction to form a hydroxyl group-containing reaction product, and adding a compound having at least one anhydride group to conduct a polymerization reaction. The first mixture includes an epoxy compound having at least two epoxy groups, which is represented by the following Formula (i), and a compound having at least one carboxyl group and at least one ethylenically unsaturated group. In one embodiment, the ring-opening reaction is preferably conducted at a temperature ranging from 100° C. to 120° C. In one embodiment, the ring-opening reaction is conducted for a period ranging from 6 hours to 12 hours.

In one embodiment, the bisphenol fluorene-based resin is represented by Formula (I):

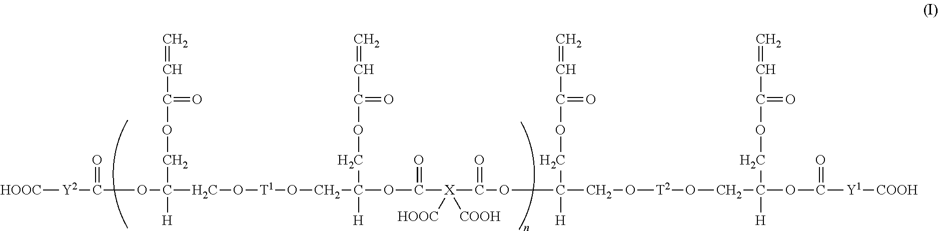

wherein T¹ and T² are independently represented by

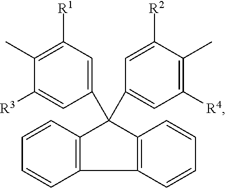

wherein R¹, R², R³, and R⁴ are independently selected from the group consisting of hydrogen, halogen, a C₁-C₅ alkyl group, a C₁-C₅ alkoxy group, a C₆-C₁₂ aryl group, and a C₆-C₁₂ aralkyl group;

X is a tetravalent organic group;

Y¹ and Y² independently represent a bivalent organic group; and

n represents an integer ranging from 1 to 30, a plurality of X's are the same or different and a plurality of R⁴'s are the same or different when n is 2 or more.

Preferably, the tetravalent organic group is selected from the group consisting of

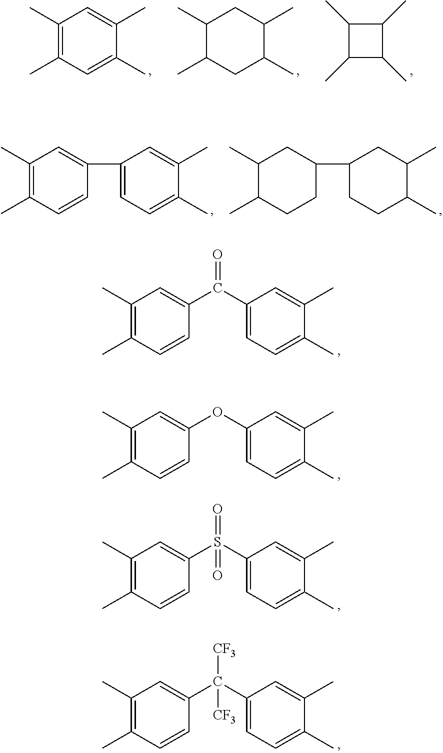

and combinations thereof.

Preferably, the divalent organic group is selected from the group consisting of —CH₂—CH₂—,

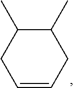

and combinations thereof.

### <<Epoxy Compound Having at Least Two Epoxy Groups>>

In the present invention, the epoxy compound having at least two epoxy groups is represented by Formula (i):

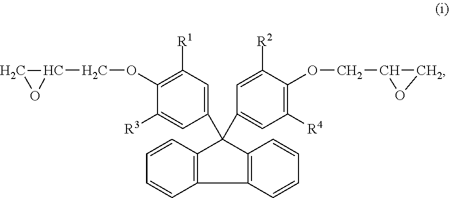

wherein R¹, R², R³, and R⁴ are independently selected from the group consisting of hydrogen, halogen, a C₁-C₅ alkyl group, a C₁-C₅ alkoxyl group, a C₆-C₁₂ aryl group, a C₆-C₁₂ aralkyl group, and combinations thereof.

A non-limiting example of the epoxy compound having at least two epoxy groups is an epoxy-containing bisphenol fluorene compound, which is obtained by subjecting 9,9-bis (4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis(4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorine, or the like and epihalohydrin to a reaction. Examples of epihalohydrin include, but are not limited to, epichlorohydrin and epibromohydrin. Commercially available examples of the epoxy-containing bisphenol fluorene compound include, but are not limited to, ESF-300 and the like manufactured by Nippon Steel Chemical Group; PG-100, EG-210, and the like manufactured by Osaka Gas; and SMS-F9PG, SMS-F914PG, SMS-F9PPhG, SMS-F9CrG, and the like manufactured by S.M.S Technology Co. SMS-F9PG is the epoxy compound represented by Formula (i), wherein R¹, R², R³, and R⁴ represent hydrogen.

### <<Compound Having at Least One Carboxyl Group and at Least One Ethylenically Unsaturated Group>>

In one embodiment, the compound having at least one carboxyl group and at least one ethylenically unsaturated group is selected from a group consisting of: (1) acrylic acid (referred as AA), methylacrylic acid, 2-methaacryloyloxyethylsuccinic acid, 2-methaacryloyloxybutylsuccinic acid, 2-methaacryloyloxyethyladipic acid, 2-methaacryloyloxybutyladipic acid, 2-methaacryloyloxyethylhexahydrophthalic acid, 2-methaacryloyloxyethylmaleic acid, 2-methaacryloyloxypropylmaleic acid, 2-methaacryloyloxybutylmaleic acid, 2-methaacryloyloxypropylsuccinic acid, 2-methaacryloyloxypropyladipic acid, 2-methaacryloyloxypropyltetrahydrophthalic acid, 2-methaacryloyloxypropylphthalic acid, 2-methaacryloyloxybutylphthalic acid, or 2-methaacryloyloxybutylhydrophthalic acid; (2) a compound obtained by subjecting hydroxyl-containing (meth)acrylate with a dicarboxylic acid compound to a reaction; and (3) a hamiester compound obtained by subjecting hydroxyl-containing (meth)acrylate with a compound having at least one anhydride group to a reaction.

Examples of hydroxyl-containing (meth)acrylate include, but are not limited to, (2-hydroxyethyl)acrylate, (2-hydroxyethyl)methacrylate, (2-hydroxypropyl)acrylate, (2-hydroxypropyl)methacrylate, (4-hydroxybutyl)acrylate, (4-hydroxybutyl)methacrylate, and pentaerythritol trimethacrylate).

Examples of the dicarboxylic acid compound may include, but are not limited to, adipic acid, succinic acid, maleic acid, and phthalic acid.

In another embodiment, the compound having at least one carboxyl group and at least one ethylenically unsaturated group is in an amount ranging from 2 moles to 2.4 moles based on I mole of the epoxy compound having at least two epoxy groups represented by Formula (i).

### <<Compound Having at Least One Anhydride Group>>

In one embodiment, the compound having at least one anhydride group is selected from a group consisting of a dicarboxylic anhydride compound, a tetracarboxylic anhydride compound, and the combination thereof.

Examples of the dicarboxylic anhydride compound include, but not limited to, are aliphatic-hydrocarbyl-containing dicarboxylic anhydride, alicyclic-hydrocarbyl containing dicarboxylic anhydride, and aromatic hydrocarbyl-containing dicarboxylic anhydride.

Examples of the aliphatic-hydrocarbyl-containing dicarboxylic acid anhydride include, but are not limited to, malonic anhydride, succinic anhydride, glutaric anhydride, adipic anhydride, pimelic anhydride, suberic anhydride, azelaic anhydride, sebacic anhydride, acetylsuccinic anhydride, citraconic anhydride, citric anhydride, tartaric anhydride, maleic anhydride, itaconic anhydride, 2-oxoglutaric anhydride, and diethylene glycol anhydride. Examples of the alicyclic-hydrocarbyl-containing dicarboxylic anhydride include, but are not limited to, hexahydrophthalic anhydride, cyclobutane dicarboxylic anhydride, cyclopentane dicarboxylic anhydride, tetrahydrophthalic anhydride (referred as THPA), and tetrahydro trimellitic anhydride. Examples of the aromatic-hydrocarbyl-containing dicarboxylic anhydride include, but are not limited to, phthalic acid anhydride, and trimellitic acid anhydride. Preferably, the dicarboxylic anhydride compound is selected from the group consisting succinic anhydride, itaconic anhydride, tetrahydrophthalic anhydride, tetrahydro trimellitic anhydride, phthalic anhydride, trimellitic anhydride, and combinations thereof. More preferably, the dicarboxylic anhydride compound is selected from the group consisting of succinic anhydride, itaconic anhydride, tetrahydrophthalic anhydride, and combinations thereof.

In one embodiment, the dicarboxylic anhydride compound may be used alone or in admixture.

In one embodiment, the tetracarboxylic anhydride compounds include, but are not limited to, aliphatic-hydrocarbyl-containing tetracarboxylic dianhydride, alicyclic-hydrocarbyl-containing tetracarboxylic dianhydride, and aromatic-hydrocarbyl-containing tetracarboxylic dianhydride.

Examples of the aliphatic-hydrocarbyl-containing tetracarboxylic dianhydride include, but are not limited to, butanetetracarboxylic dianhydride, pentanetetracarboxylic dianhydride, and hexanetetracarboxylic dianhydride.

Examples of the alicyclic-hydrocarbyl-containing tetracarboxylic dianhydride include, but are not limited to, cyclobutanetetracarboxylic dianhydride, cyclopentanetetracarboxylic dianhydride, cyclohexanetetracarboxylic dianhydride, cycloheptanetetracarboxylic dianhydride, and bis(3,4-dicarboxycyclohexyl)dianhydride.

Examples of the aromatic-hydrocarbyl-containing tetracarboxylic dianhydride include, but are not limited to, pyromellitic dianhydride (referred as PMDA), benzophenonetetracarboxylic dianhydride, biphenyl-tetracarboxylic dianhydride (referred as BPDA), diphenyl ether tetracarboxylic dianhydride, 4,4′-(hexafluoroisopropylidene)diphthalic anhydride, and diphenylsulfonetetracarboxylic acid dianhydride.

Preferably, the tetracarboxylic anhydride compound is selected from the group consisting of biphenyl-tetracarboxylic dianhydride, benzophenonetetracarboxylic dianhydride, diphenyl ether tetracarboxylic dianhydride, and combinations thereof.

More preferably, the tetracarboxylic anhydride compound is selected from the group consisting of biphenyl-tetracarboxylic dianhydride, diphenyl ether tetracarboxylic dianhydride, and combinations thereof.

In one embodiment, the tetracarboxylic anhydride compound may be used alone or in admixture. In another embodiment, the compound having at least one anhydride group is in an amount ranging from 0.3 mole to 1 mole based on 1 mole of the epoxy compound having at least two epoxy groups represented by Formula (i).

### <Quaternary Ammonium Salt Compound>

In one embodiment, the quaternary ammonium salt compound is selected from the group consisting of tetrakis(C₁-C₆ alkyl)ammonium halide, tris (C₁-C₆ alkyl)aryl ammonium halide, N-alkylpyridinium halide, and combinations thereof.

Examples of the tetrakis(C₁-C₆ alkyl)ammonium halide include, but are not limited to, tetramethyl ammonium chloride, tetraethyl ammonium chloride, tetraethyl ammonium bromide, tetrabutyl ammonium chloride, and tetrabutyl ammonium bromide. The tetrakis(C₁-C₆ alkyl)ammonium halide may be used alone or in admixture.

Examples of the tris (C₁-C₆ alkyl)aryl ammonium halide include, but are not limited to, trimethyl phenyl ammonium chloride, triethyl benzyl ammonium chloride (referred as TEBAC), and tripropyl phenyl ammonium chloride. The tris(C₁-C₆ alkyl)aryl ammonium halide may be used alone or in admixture.

A non-limiting example of the N-alkylpyridinium halide is N-methylpyridinium chloride.

In one embodiment, the quaternary ammonium salt compound is in an amount greater than 0.07 part by weight and smaller than 0.82 part by weight based on 100 parts by weight of the total amount of the bisphenol fluorene-based resin.

In another embodiment, the quaternary ammonium salt compound is preferably in an amount greater than 0.1 part by weight and smaller than 0.82 part by weight, and more preferably in an amount ranging from 0.136 part by weight to 0.68 part by weight based on 100 parts by weight of the total amount of the bisphenol fluorene-based resin. The term “total amount of the bisphenol fluorene-based resin” means a total amount of the epoxy compound having at least two epoxy groups represented by Formula (1) the compound having at least one carboxyl group and at least one ethylenically unsaturated group, and the compound having at least one anhydride group. Alternatively, the quaternary ammonium salt compound is in an amount ranging from 0.075 wt % to 0.374 wt % based on 100 wt % of the alkali-soluble resin component.

### <Solvent>

The solvent is chosen such that the epoxy compound having at least two epoxy groups represented by Formula (i), the compound having at least one carboxyl group and at least one ethylenically unsaturated group, the compound having at least one anhydride group and the quaternary ammonium salt compound may be dissolved in the solvent and may not react with the solvent.

In one embodiment, examples of the solvent include, but are not limited to, (1) alcohol compounds: ethanol, propanol, isopropanol, butanol, isobutanol, 2-butanol, hexanol, and ethylene glycol; (2) ketone compounds methyl ethyl ketone and cyclohexanone; (3) aromatic hydrocarbon compounds: toluene and xylene; (4) cellosolve compounds cellosolve and butyl cellosolve; (5) carbitol compounds: carbitol and butyl carbitol; (6) propylene glycol alkyl ether compounds: propylene glycol monomethyl ether; (7) poly(propylene glycol) alkyl ether compounds: di(propylene glycol) methyl ether; (8) acetate compounds: ethyl acetate, butyl acetate, ethylene glycol monoethyl ether acetate, and propylene glycol methyl ether acetate (referred as PGMEA); (9) lactate compounds: ethyl lactate and butyl lactate; and (10) dialkyl glycol ether compounds. The solvent may be used alone or in admixture.

In one embodiment, the solvent is in an amount ranging from 10 wt % and smaller than 95 wt % based on 100 wt % of the alkali-soluble resin component. In another embodiment, the solvent is in an amount ranging from 40 wt % to 60 wt % based on 100 wt % of the alkali-soluble resin component.

### [Alkali-Soluble Resin Component]

In one embodiment, a preparation method of the alkali-soluble resin component includes a step of subjecting a second mixture to a polymerization reaction, wherein the second mixture includes the epoxy compound having at least two epoxy groups represented by Formula (i), the compound having at least one carboxyl group and at least one ethylenically unsaturated group, the compound having at least one anhydride group, the quaternary ammonium salt compound, and the solvent. Preferably, the second mixture further includes an inhibitor. In another embodiment, the alkali-soluble resin component has an acid value ranging from 10 mgKOH/g to 150 mgKOH/g, and preferably from 30 mgKOH/g to 90 mgKOH/g.

### <Inhibitor>

The inhibitor is used to prevent the compound having at least one carboxyl group and at least one ethylenically unsaturated group from self-polymerization.

In one embodiment, the inhibitor include, but are not limited to, (1) monophenol compounds: hydroquinone, methylhydroquinone, dibutyl hydroxyl toluene, 2,6-di-tert-butyl-p-cresol(referred as BHT), tert-butyl-4-methoxyphenol 2,6-di-tert-butyl-p-ethylphenol, and stearyl-3-(3,5-di-tert-butyl-4-hydroxyphenyl)propionate; (2) bisphenol compounds: 2,2′-methylene-bis-(4-methyl-6-tert-butylphenol), 2,2′-methylene-bis-(4-ethyl-6-tert-butylphenol), 4,4′-thio-bis-(3-methyl-6-tert-butylphenol), 4,4′-butylidene-bis-(3-methyl-6-tert-butylphenol), and 3,9-bis-[1,1-dimethyl-2{β-(3-tert-butyl-4-hydroxy-5-methylphenol)propionyloxy}ethyl]-2,4,8,10-tetraox aspiro[5.5]undecane; (3) polyphenol compounds: 1,1,3-tris-(2-methyl-4-hydroxy-5-tert-butylphenyl)butane, 1,3,5-trimethyl-2,4,6-tris-(3,5-di-tert-butyl-4-hydroxybenzyl)benzene, tetrakis[methylene-3-(3′,5′-di-tert-butyl-4′-hydroxyphenyl)propionate]methane, bis[3,3′-bis(4′-hydroxy-3′-tert-butylphenyl)butyric acid]glycol ester, and 1,3,5-tris(3′,5′-di-tert-butyl-4′-hydroxybenzyl-S-triazine-2,4,6-(1H,3H,5H)trione. The inhibitor maybe used alone or in admixture.

In one embodiment, the inhibitor is in an amount ranging from 0.01 part by weight to 3 parts by weight based on 100 parts by weight of the bisphenol fluorene-based resin.

In another embodiment, the inhibitor is in an amount ranging from 0.03 part by weight to 1 part by weight based on 100 parts by weight of the bisphenol fluorene-based resin.

### [Photosensitive Resin Composition]

A photosensitive resin composition according to this invention includes the alkali-soluble resin component and a photoinitiator.

The photoinitiator used in the present invention may be identical to the photoinitiator commonly used in the photosensitive resin composition for a color filter or a black matrix.

Preferably, the photosensitive resin composition further includes pigment.

The pigment used in the present invention may be identical to the pigment commonly used in the photosensitive resin composition for a color filter or a black matrix.

Preferably, the photosensitive resin composition further includes a solvent.

The solvent is chosen such that the alkali-soluble resin component and the photoinitiator may be dissolved in the solvent and may not react with the solvent. The solvent is preferably volatile. Examples of the solvent are identical to the aforementioned solvents.

The present invention will be further described by way of the following examples. It is understood that the following examples are used for illustration, and should not be construed as limiting the implementation of the present invention.

### EXAMPLES

### Example 1

Step 1: 46.2 g of SMS-F9PG (manufactured by S.M.S Technology Co.), 14.98 g of AA, 0.114 g TEBAC, and 0.047 g of BHT were dissolved in 32.34 g of PGMEA, and a reaction was performed at 110° C. for 20 hours to form a first mixture.

Step 2: 14.7 g of BPDA and 24 g of PGMEA were added in the first mixture of Step 1 at 110° C., and a reaction was performed for 2 hours to form a second mixture.

Step 3: 7.6 g of THPA and 12 g of PGMEA were added in the second mixture of step 2 at 110° C., and a reaction was performed for 2 hours to obtain the alkali-soluble resin component.

### Examples 2 to 9 and Comparative Examples 1 to 7

Each of the alkali-soluble resin components of Examples 2 to 9 and Comparative Examples 1 to 7 was prepared by using the method identical to that of Example 1, except that the amount of TEBAC, the reaction temperature, and the reaction time of Step 1 were different from those in Example 1. Details are shown in Table 1.

### <<Evaluation Methods>>

### 1. Evaluation of Homogeneous State:

Existence of precipitates in each of the alkali-soluble resin components of Examples 1 to 9 and Comparative Examples 1 to 7 was observed.
◯: precipitates do not exist
×: precipitates exist

### 2. Reactivity:

After reaction of Step 1, an epoxy equivalent weight is used as an index for evaluating the reactivity.
◯: the epoxy equivalent weight is greater than 10,000 g/eq. This indicates that the reactivity in Step 1 is good.
×: the epoxy equivalent weight is less than 10,000 g/eq. This indicates that the reactivity in Step 1 is poor, and the reaction was not complete and excess epoxy groups remain.

### 3. Distribution of Molecular Weight:

In Examples 5 to 7 and Comparative Examples 6 to 7, a content of a polymer with the molecular weight (Mw) greater than 10,000 of each of the alkali-soluble resin components was measured by Gel Permeation Chromatography (referred as GPC).

TABLE 1

| | | | | | | | | | | | | Content of |
|---|---|---|---|---|---|---|---|---|---|---|---|---|
| | | | | | | | | | | | | polymer |
| | | | | | Bisphenol | | | | Epoxy | | | with Mw of |
| | TEBAC | | | | Fluorene-based | PGMEA | Temp | Time | Equivalent | Homogenous | | greater than |
| | mmole | | g | % ^{a} | Resin (g)^{c} | (%) ^{b} | (° C.) | (hr) | (g/eq) | State | Reactivity | 10,000 (wt %) |
| Examples | 1 | 0.5 | 0.114 | 0.075 | 83.48 | 44.97 | 110 | 20 | 11,111 | O | O | — |
| | 2 | 1 | 0.228 | 0.15 | | 44.93 | 110 | 8 | 10,000 | O | O | — |
| | 3 | 1 | 0.228 | 0.15 | | 44.93 | 110 | 16 | 33,333 | O | O | — |
| | 4 | 2 | 0.456 | 0.299 | | 44.88 | 100 | 12 | 12,500 | O | O | — |
| | 5 | 2 | | | | | 110 | 6 | 12,500 | O | O | 15.25 |
| | 6 | 2 | | | | | 110 | 9 | 25,000 | O | O | 7.21 |
| | 7 | 2 | | | | | 110 | 12 | 33,333 | O | O | 8.89 |
| | 8 | 2.5 | 0.569 | 0.374 | | 44.85 | 100 | 8 | 12,500 | O | O | — |
| | 9 | 2.5 | | | | | 100 | 9 | 14,286 | O | O | — |
| Comparative | 1 | 0.25 | 0.057 | 0.037 | | 45.00 | 110 | 10 | 2,439 | O | X | — |
| Examples | 2 | 0.25 | | | | | 110 | 12 | 2,778 | O | X | — |
| | 3 | 0.25 | | | | | 110 | 16 | 3,846 | O | X | — |
| | 4 | 0.25 | | | | | 110 | 20 | 5,263 | O | X | — |
| | 5 | 3 | 0.683 | 0.448 | | 44.81 | 100 | 8 | 16,667 | X | O | — |
| | 6 | 3 | | | | | 100 | 9 | 20,000 | X | O | 1.92 |
| | 7 | 4.47 | 1.018 | 0.666 | | 44.70 | 100 | 6 | 14,286 | X | O | 6.61 |

^{a}: [(TEBAC × 100)/(F9PG + TEBAC + AA + BPDA + THPA + PGMEA)];
^{b}: [(PGMEA × 100)/(F9PG + TEBAC + AA + BPDA + THPA + PGMEA)];
^{c}:F9PG + AA + BPDA + THPA;
┌—┘: not measured

As shown in Table 1, Examples 1 to 9 exhibited superior evaluation results in terms of the homogenous state and the reactivity of Step 1. On the other hand, Comparative Examples 1 to 4 had excess epoxy groups by virtue of inferior reactivity of Step 1 and incomplete reaction. Comparative Examples 5 to 7 had precipitates.

Although the contents of the polymer with 10,000 molecular weight of Examples 5 to 7 are more than that of Comparative Examples 6 to 7, Examples 5 to 7 exhibited superior evaluation result of homogenous state by controlling the content of the quaternary ammonium salt compound.

To sum up, the reactivity for manufacturing the bisphenol fluorene-based resin is facilitated by controlling the content of Quaternary ammonium salt compound. Meanwhile, the alkali-soluble resin component in a homogeneous state may be obtained.

While the present invention has been described in connection with what are considered the most practical and preferred embodiments, it is understood that this invention is not limited to the disclosed embodiments but is intended to cover various arrangements included within the spirit and scope of the broadest interpretation so as encompass all such modifications and equivalent arrangements.

What is claimed is:

1. An alkali-soluble resin component, comprising:
a bisphenol fluorene-based resin;
a quaternary ammonium salt compound; and
a solvent,
wherein
said quaternary ammonium salt compound is in an amount greater than 0.01 part by weight and smaller than 0.82 part by weight based on 100 parts by weight of said bisphenol fluorene-based resin, and said bisphenol fluorene-based resin is represented by formula (I): 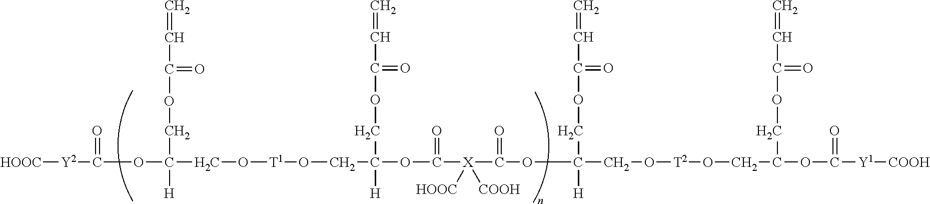
wherein
T¹ and T² independently represent 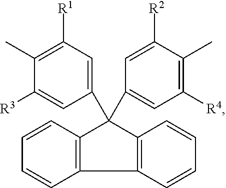
wherein R¹, R², R³, and R⁴ are independently selected from the group consisting of hydrogen, halogen, a C₁-C₅ alkyl group, a C₁-C₅ alkoxy group, a C₆--C₁₂ aryl group, and a C₆-C₁₂ aralkyl group;
X is a tetravalent organic group;
Y¹ and Y² independently represent a bivalent organic group; and
n represents an integer ranging from 1 to 30, a plurality of X's are the same or different and a plurality of R⁴'s are the same or different when n is 2 or more.

2. The alkali-soluble resin component according to claim 1, wherein said alkali-soluble resin component has an acid value ranging from 10 mgKOH/g to 150 mgKOH/g.

3. The alkali-soluble resin component according to claim 1, wherein said quaternary ammonium salt compound is in an amount ranging from 0.136 part by weight to 0.68 part by weight based on 100 parts by weight of said bisphenol fluorene-based resin.

4. The alkali-soluble resin component according to claim 1, wherein said quaternary ammonium salt compound is in an amount ranging from 0.075 wt % to 0.374 wt % based on 100 wt % of said alkali-soluble resin component.

5. The alkali-soluble resin component according to claim 1, wherein said quaternary ammonium salt compound is selected from the group consisting of tetra(C₁-C₆ alkyl)ammonium halide, tri(C₁-C₆ alkyl)aryl ammonium halide, halogenated N-alkylpyridine, and combinations thereof.

6. The alkali-soluble resin component according to claim 1, wherein said tetravalent organic group is selected from the group consisting of

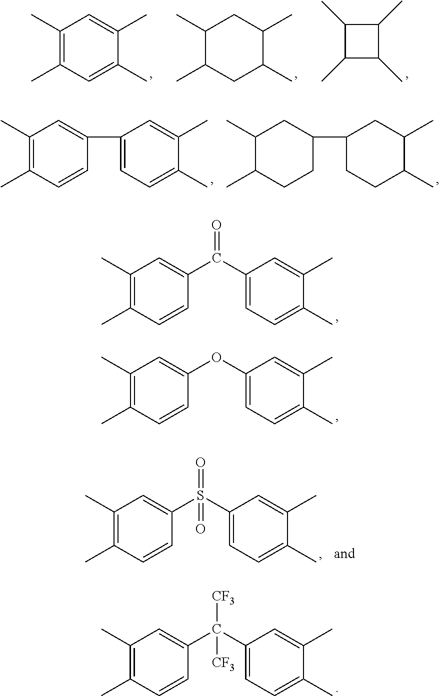

7. The alkali-soluble resin component according to claim 1, wherein said bivalent organic group is selected from the group consisting of —CH₂—CH₂— and

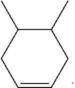

8. The alkali-soluble resin component according to claim 1, wherein said solvent is in an amount ranging from 10 wt % and smaller than 95 wt % based on 100 wt % of said alkali-soluble resin component.

9. The alkali-soluble resin component according to claim 1, further comprising an inhibitor, wherein said inhibitor is in an amount ranging from 0.01 part by weight to 3 parts by weight, based on 100 parts by weight of said bisphenol fluorene-based resin.

10. A photosensitive resin composition, comprising the alkali-soluble resin component according to claim 1 and a photoinitiator. 20
